(19) United States
(12) Patent Application Publication
(10) Pub. No.: US 2015/0228035 A1
(43) Pub. Date: Aug. 13, 2015

(54) SOCIAL CARE TASKS

(71) Applicant: Aetna Inc., Hartford, CT (US)

(72) Inventors: David S. Williams, III, Los Angeles, CA (US); Chandrasekhar Rentachintala, Foster City, CA (US); Jon Chun, San Jose, CA (US)

(73) Assignee: AETNA INC., Hartford, CT (US)

(21) Appl. No.: 14/179,110

(22) Filed: Feb. 12, 2014

(51) Int. Cl. G06Q 50/00; G06F 19/00

(52) U.S. Cl. CPC G06Q 50/01; G06F 19/322; G06F 19/3456

(57) ABSTRACT

A method of managing care requests in a social care network is described. The method includes associating, by a care request processor, a plurality of individuals as members of the social care network. The care request processor receives care request information for an individual member of the social care network and generates and manages tasks based in part on the care request information. Embodiments further include providing contextual advertisements within the network, providing access to personal health information and translating between clinical language and natural language as needed.

### BACKGROUND OF THE INVENTION

People create to-do items and tasks for various reasons. A task is generally some activity that a person wants to or needs to complete. Some tasks have a defined deadline while other tasks may not have a deadline. A task may include, for example, picking up an item from the store. Historically, tasks have been managed by listing them on a piece of paper and crossing them off when they are completed.

People also manage to-do items and tasks in various ways using computers, smartphones, tablet computers and other devices. For example, some programs allow users to electronically create a list of tasks. When a task is completed, the task can be checked off or completed.

In the context of the healthcare system, patients often have to manage many tasks. For example, patients may need to go to a pharmacy to pick up prescription drugs and other items. Patients also need to go to various medical appointments. Additionally, patients may need to go to other stores to purchase specific items, such as crutches. If a patient needs assistance with a task, the patient must contact family and friends and individually ask for assistance. Tasks that family and friends offer to do are then managed by them using their own systems.

When family and friends offer to complete a task, they do not have access to any medical information and records for the patient. Further, even though coupons and other information from retailers may exist, family and friends have to search out relevant information from the retailers they plan to visit.

### BRIEF SUMMARY OF THE INVENTION

This disclosure describes systems and methods for social care networks. In one embodiment, a method of managing care requests in a social care network is described. The method includes associating, by a care request processor, a plurality of individuals as members of the social care network. The care request processor receives care request information for an individual member of the social care network. The care request processor generates at least one task based on the received care request information. The task is posted by the care request processor to the social network. The care request processor receives an acceptance of the task from a member of the social care network. The care request processor receives a completion indication of the task from the member of the social care network.

Other embodiments provide a method of managing tasks in a social network. The method includes associating, by a task processor, a plurality of individuals as members of the social network. The task processor receives task information for an individual member of the social network. The method further includes posting, by the task processor, the task to the social network. The task processor receives an acceptance of the task from a member of the social network. The task processor receives a completion indication of the task from the member of the social network.

Other embodiments provide a method of generating contextual advertisement placements in a task management system. The method includes tracking, by a context processor, historical data for tasks accepted by an individual and tasks not accepted by the individual. The context processor analyzes profile information for a plurality of users of the task management system. The method further includes associating, by the context processor, the individual with similar users and groups. The context processor analyzes geolocation data for the individual and analyzes a personal health information record associated with the individual. The context processor places a contextual advertisement for the individual.

Other embodiments provide a method of maintaining access to a personal health information record. An information record processor associates a user with the personal health information record of a patient. The information record processor transmits terms for accessing the personal health information record to the user. The method includes receiving, by the information record processor, acceptance of the terms for accessing the personal health information record from the user. The information record processor provides access to the personal health record.

### BRIEF DESCRIPTION OF THE SEVERAL VIEWS OF THE DRAWING(S)

FIG. 1 is a diagram of a system for managing care requests in a social care network according to one embodiment.

FIG. 2 is a diagram illustrating application personalization according to one embodiment.

FIG. 3 is a diagram of a system for controlling personal health information access according to one embodiment.

FIG. 4 is a flowchart of a method for managing care requests in a social care network according to one embodiment.

FIG. 5 is a flowchart of a method for generating contextual advertisement placements in a task management system according to one embodiment.

FIG. 6 is a flowchart of a method for maintaining access to a personal health information record according to one embodiment.

FIG. 7 is a schematic diagram showing hardware components of a social care network according to one embodiment.

### DETAILED DESCRIPTION OF THE INVENTION

Embodiments of the disclosure provide systems and methods for managing care requests in a social network including controlling access to personal health information and placing contextual advertisements in the network. Some embodiments provide the ability for a private social network to create, share and accept activities related to providing support for an individual and/or for each other. In some embodiments, all members can create tasks and all members can accepts tasks. For example, a social network of family and friends may provide support for an elderly person. Further, data may be shared with other clinical and non-clinical information networks. Personal health information may be selectively shared with individuals in the network. Additionally, appropriate recommendations and advertisements may be shown to members of the network based on various factors including the activities being performed.

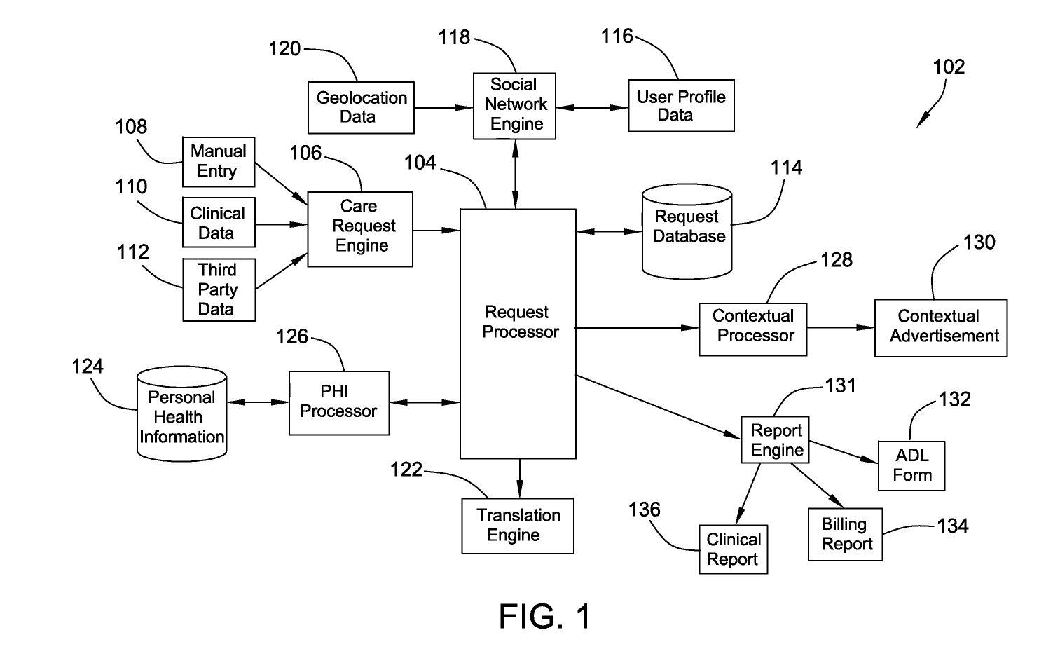

Turning to FIG. 1, a system for managing care requests in a social care network, managing personal health information and placing contextual advertisements according to one embodiment is shown. The illustrated embodiment relates to healthcare, however the described systems and methods apply broadly to managing tasks in a private social network. A management system 102 is illustrated. The management system 102 includes a request processor 104. In some embodiments, the management system 102 enables members of a private social network to create, share and accept activities, or tasks, related to providing support for an individual and/or for each other. Data relating to the tasks may flow into other clinical and non-clinical information networks.

The request processor 104 connects to a care request engine 106. The management system 102 allows for multi-format activities translation. This allows for collecting a range of data inputs (e.g., user generated tasks, health, contextual activity, behavioral patterns) from disparate sources, letting users manage them in the social network (with recommendations based on data analytics), and then automatically creating a series of customized outputs based upon the audience or use-case for the output. For example, the care request engine accepts manually entered data 108, clinical data 110 and third party data 112. The manually entered data 108 may include a request by a member of a private social network. The request can be a task that the member needs assistance with, such as “pick up prescription medicine.” Alternatively, a member can create a task for another person. For example, a person can create a task to pick up a prescription for an elderly member of the private social network. In some embodiments, a person does not have to be an actual member of the network to have tasks created on their behalf. An elderly person may be the subject of tasks, but may not actually join the private social network. As explained below, after a task is created members of the private social network would then be able to accept a task related to the request and complete the task.

Clinical data 110 such as electronic medical records, health insurance data and pharmacy benefits data may also be used as an input to the care request engine 106. In one example, the request processor 104 may analyze the clinical data 110 received from the care request engine 106 and determine that a prescription for a member of a private social network must be refilled. The request processor 104 then creates a task to refill the prescription. The task is stored in the request database 114. In another embodiment, the request processor 104 may analyze the third party data 112 received from the care request engine 106. Third party data includes shopping behavior, employer inputs and other data. For example, a member of the private social network may be on a shopping website looking at a blood pressure monitor. The webpage may include a button for the social network. If the user pushes the button, the data related to the monitor will be sent to the care request engine 106. The request processor 104 then creates a task to purchase the monitor and the task is stored in the request database 114. In some embodiments, the request processor 104 will create tasks, such as healthcare activity tasks related to the third party data. For example, if a user is shopping for a blood pressure monitor, the request processor 104 may create task to have a medical checkup because the user may have hypertention.

Users join a private social network to provide support to members of the group. In one embodiment, the request processor 104 associates members of the private social network. Users enter profile information 116 and indicate which social network they wish to join. As discussed below, geolocation data 120 is gathered for the members. The geolocation data can be used for various purposes including contextual advertisements and to promote certain tasks. The social network engine 118 accepts members and provides information to members. Members can access information, such as the status of tasks through a variety of devices such as mobile smartphone applications, tablet computers and general purpose computers. The data can be accessed through stand alone applications or through Web interfaces. In some embodiments, new data is pushed to member devices. In some embodiments, the system integrates with existing to-do list applications and calendar applications.

Tasks are managed and shared within the private social network. All users may see, accept and act on available task activities. When a task is available, it is posted to the social network by the request processor 104. Based on the profile data 116 and geolocation data 120, tasks can be recommended/promoted to certain members. For example, if a task requires purchasing an item at a particular store, geolocation data may be used to determine a member is close to the store. The task can then be recommend to the member through a text message, push message, automated phone call or other mechanism. Recommendations could be based on crowd sourced tasks, recommendations based clinical data 110 such as on health outcomes data, advertising/promotional requests, employer sponsored programs, and others.

A translation engine 122 translates from clinical language to natural language. For example, a custom discharge plan for a patient may be received as clinical data 110. The care request engine 106 may process the data and send it to the request processor. The clinical language may be “ambulate assist WC.” This language is sent to the translation engine 122. The translation engine 122 translates the clinical language into, for example “Help member out of wheelchair.” A task can then be created by the request processor 104 and stored in the request database. In addition to direct mappings of language, the translation engine 122 can also use the network to translate clinical language to natural language. For example, if 90% of the people in the network use “Task A” to describe “ambulate assist WC” then “Task A” is a likely translation. This could be in a drop-down like “Do you want to do Task A” which if selected would be a way to essentially crowd-source the translations. Additionally, when translating clinical language to natural language, multiple tasks can be created. For example, there may be five discrete tasks related to a single clinical description. Recurring tasks can also be created. For example, “bathe patient” can be set to recur every three days. Completion of this series of tasks can be recorded as individual events so the clinical request of “bathe patient” could be recorded as completed 14 out of 19 possible times and the subtasks could have been completed in any number of combinations.

Additionally, translation engine 122 may convert natural language to clinical language. Members may use natural language to create tasks and track completion. The translation engine 122 may generate a clinical history of treatments that is used for clinical reporting/inclusion in an individual's Electronic Health Record. For example, a member may use manual entry 108 to create a task, “help mom out of wheelchair”. The translation engine 122 would translate this to “Ambulate Assist WC” for reporting and clinical history.

After a task is created, the request processor 104 sends the task to the social network engine 118. In one embodiment, the social network engine 118 pushes the task to member devices. Members can then view the task and accept the task. Once a member accepts a task, the social network engine notifies the request processor 104 that a task has been accepted. An indication that the task is accepted and the identity of the member that accepted it is stored in the request database 114. In some embodiments, all members can view the status of all tasks, including the identity of the person that accepted tasks. When a task is completed, the member sends an indication that the task is completed to the social network engine 118 and request processor 104. The social network engine 118 sends the status to the request processor 104 and it is marked as complete in the request database 114. In some embodiments, the request database 114 stores both the member that accepted a task and members that did not accept the task.

In some embodiments, the request processor 104 interfaces with the report engine 131 to generate an activities of daily living form 132 that contains required information based on completing an auto-generated checklist of questions and actions. In this embodiment, home healthcare professionals can be members of the private social network. As they complete tasks, the request processor 104 and report engine 131 generate activities of daily living form 132 on an automated or manual basis. In some embodiments, multiple people can collectively complete the requirements of a activities of daily living form. For example, multiple tasks can be created and different nurses can complete each task, for example on different shifts. The form can then be generated and indicate that multiple people completed the tasks. The form can then be transmitted to an insurance provider or other entity for reimbursement. In some embodiments, reports are generated for billing systems 134, clinical systems and reporting 136.

In some embodiments, the system may provide access to personal health information to members of the private social network. For example, the request processor 104 may analyze the clinical data 110 received from the care request engine 106 and determine that a prescription for a member of a private social network must be refilled. The request processor 104 then creates a task to refill the prescription. The prescription is personal health information and can be accessed from the personal health information database 124, through the personal health information processor 126. As explained below, each record in the personal health information database 124 includes data fields for people associated with the record. Example fields include subject, creator and access, indicating the person the record is about, who created it and who can see it respectively.

Additionally, the request processor 104 interfaces with a contextual processor 128. In some embodiments, the contextual processor places highly relevant advertisements for members of the private social network. The advertisements can be placed on webpages, or applications depending on how a member is viewing the social network. The system selects a relevant ad to uniquely target the individual based upon a number of inputs. Example inputs include: history of sponsored actions (promotions) taken/not taken by the user; type of request that has been created. (e.g., refill order, hospital visit, question asked to the network, etc.); analytics and profiling information from the network of users. (e.g, other people in the network similar to you have responded to something); associations that you are a member of (e.g., employer, pharmacy choice, etc.); geolocation of where the user is; and an individual's protected PHI (e.g., age, disease state, last medical visit, etc.).

Advertisements can be sent to members working on a task or to members who may need assistance. For example, a 10% off coupon at store may be sent to a user selecting a humidifier, placing it in the cart and creating a request out of it and posting this revised offer to the system 102. The advertisements can be placed not only as display ads, but also “recommended tasks” which are contextually placed within the flow such as “Purchase humidifier” if a medical condition indicates a humidifier may help. The recommend task may include a particular humidifier or store to purchase it at.

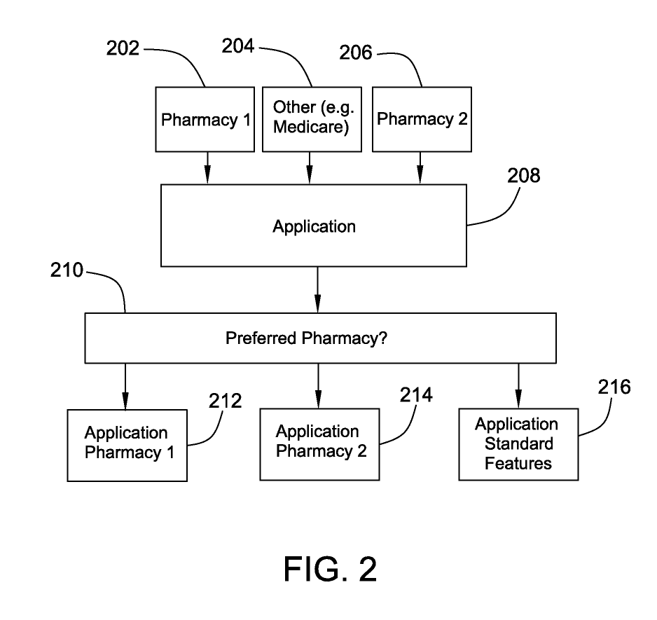

FIG. 2 is a diagram illustrating application personalization according to one embodiment is shown. In some embodiments, co-branded applications can be dynamically generated based on a selection criteria either actively or passively determined from a user's input. The application can be a mobile application or a web page. Various entities can participate in the application customization program. For example, in the illustrated embodiment a first pharmacy 202, Medicare 204 and a second pharmacy 206 are participants. Each of these participants are either pre-populated in the application 208 or are dynamically loaded. The application determines if the user has a preferred pharmacy by prompting 210 the user. Based on the user's response, the application is customized for the user and appropriate contextual advertisements are displayed. For example, if the user selects the first pharmacy, programs specific to that pharmacy are displayed 212, such as discounts, product recommendations, loyalty programs and bar code scanning features. Likewise, if the second pharmacy is selected, programs specific to that pharmacy are displayed 214. Finally, the user may not select a preferred pharmacy. In that case, the standard programs are displayed 216 including contextual advertisements generated from other data sources, as explained elsewhere.

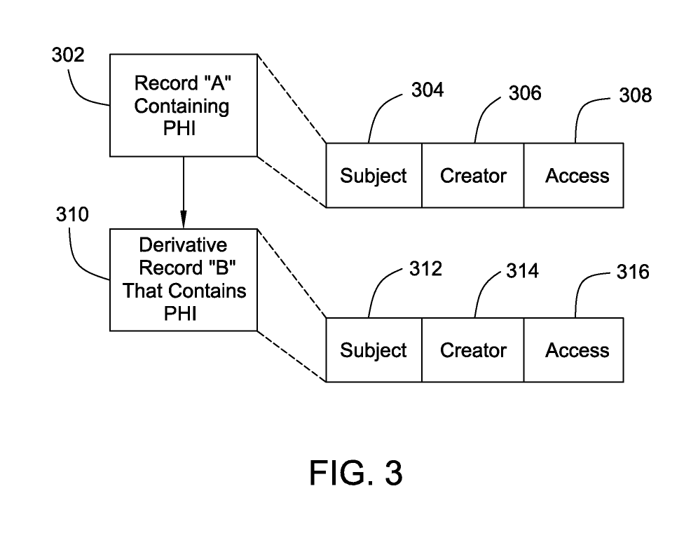

FIG. 3 is a diagram of a system for controlling personal health information access according to one embodiment. As described above, in some situations it is helpful to provide members of the private social network with access to personal health information for one of the members. For example, a prescription is personal health information and picking up the prescription may be one of the tasks. Typically, personal health information is treated as a single monolithic piece of information in which all information related to a single individual is treated the same way. Access to everything (and derivative information) is also treated the same, making the information inherently un-shareable because of access rights.

According to some embodiments, discrete pieces of personal health information can be shared with others in a dynamic way. Record A 302 contains personal health information. It is a primary record. Associated with record A 302 is its subject 304. The subject is the person the record pertains to. Also associated with record A 302 is the creator 306 of the record and a list of who has access 308 to the record. The access list can contain a single person, some number of people or a group of people, such as all members of a private social network.

A person with personal health record authorization, such as a nurse, can create derivative records and define who can see those derivative records. In the illustrated embodiment, record B 310 is a derivative of record A 302. The subject 312 of record B 310 is the same as the subject 304 of record A 302. The creator 314 of record B 310 is the person that created it. The person that created record B 310 can define who has access 316 to record B 310. An authorization mechanism is used to enable access for third parties. The authorization mechanism includes (1) a secure method for assigning personal health information access privileges to another system user electronically, (2) an acceptance of the terms for acting on behalf of another (e.g., aging parent, child) and sharing personal health information, (3) a means of setting an expiration for authorization and (4) the option to decide whether historical information is shared with a user newly authorized for personal health information.

The personal health information processor 126 (FIG. 1) manages access to personal health information. For example, the personal health information processor 126 may transmit terms for accessing the personal health information record to a user and receive a response, such as an electronic signature indicating acceptance of the terms. The personal health information can then be used to fulfill tasks in the private social network. In some embodiments, tasks created based on personal health information are only visible to those with access to view the information. For example, Person A can grant the right to see Person A's medical list to Person B and Person C (but not Person D). Person B can then use that information to create a medication refill request based on Person A's lab report and post a request to get the prescription. Only Person A, B, and C (and not D) will see that request. If at some point in the future person D is given access rights, he will be able to view the request.

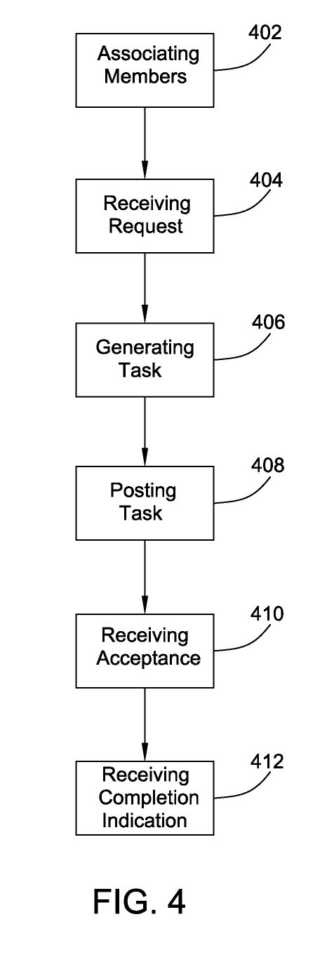

FIG. 4 is a flowchart of a method for managing care requests in a social care network according to one embodiment. In the illustrated embodiment, a care request processor associates a plurality of individuals as members of the social care network at step 402. As illustrated in FIG. 1, the individuals may be associated by the request processor 104 or the social network engine 118. The social network engine 118 may be incorporated into the request processor 104. At step 404, the care request processor receives care request information for an individual member of the social care network. The care request information can be manually entered 108, clinical data 110, or third party data 112. The care request information may also proceed to a care request engine. In some embodiments, the care request engine 106 is part of the request processor 104. The care request processor generates at least one task based on the received care request information at step 406.

At step 408, the task is posted by the care request processor to the social network. The task may be visible to all members of the social network or visible to certain members of the network. A member of the social network can then accept the task, indicating that they will perform the task. The care request processor 104 receives an acceptance of the task from the member of the social care network at step 410. When the task is completed, the member can indicate that it was completed. At step 412, the care request processor 104 receives a completion indication of the task from the member of the social care network.

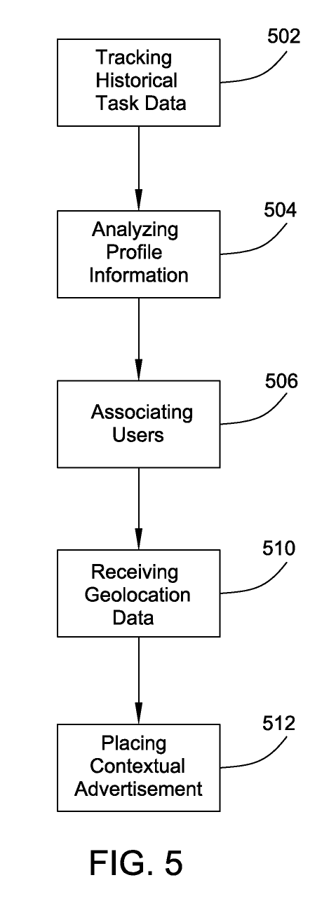

FIG. 5 is a flowchart of a method for generating contextual advertisement placements in a task management system according to one embodiment. The contextual advertisements include sponsored actions or promotions. A context processor tracks historical data for tasks accepted by individual and tasks not accepted by the individual at step 502. In some embodiments, the historical data includes (1) History of sponsored actions (promotions) taken/not taken by the individual; and (2) Type of request that has been created. (e.g., refill order, hospital visit, question asked to the network, etc.).

At step 504, the context processor analyzes profile information for a plurality of users of the task management system. In some embodiments, the analysis includes analytics and profiling information from the network of users. (e.g, other people in the network similar to the user that have responded to something). The method further includes associating, by the context processor, the individual with similar users and groups at step 506. Example associations include groups that the individual is a member of (e.g., employer, pharmacy choice, etc.). At step 510, the context processor analyzes geolocation data for the individual and analyzes a personal health information record associated with the individual. In some embodiments, this historical data and profile information can be stored in system 102 as part of a user profile 116, request database 114 and/or personal health information database 124. At step 512, the context processor places a contextual advertisement for the individual. The advertisement can be placed in a dedicated application for managing the to-do items, in a webpage, or other location.

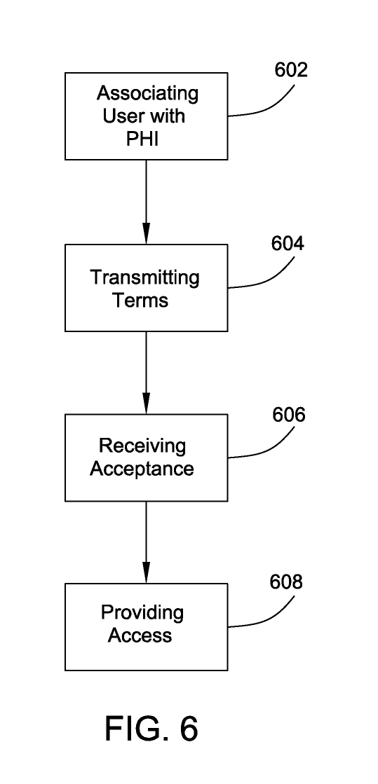

FIG. 6 is a flowchart of a method for maintaining access to a personal health information record according to one embodiment. An information record processor associates a user with the personal health information record of a patient at step 602. In this embodiment, the patient is the subject of the record. At step 604, the information record processor transmits terms for accessing the personal health information record to the user. The terms may contain a privacy agreement, limitations on the use of the information and other appropriate limitations. The method includes receiving, by the information record processor, acceptance of the terms for accessing the personal health information record from the user at step 606. In some embodiments, the acceptance is an electronic signature from the user. The information record processor provides access to the personal health record at step 608. In some embodiments, this is accomplished by adding the user to an access field for the record.

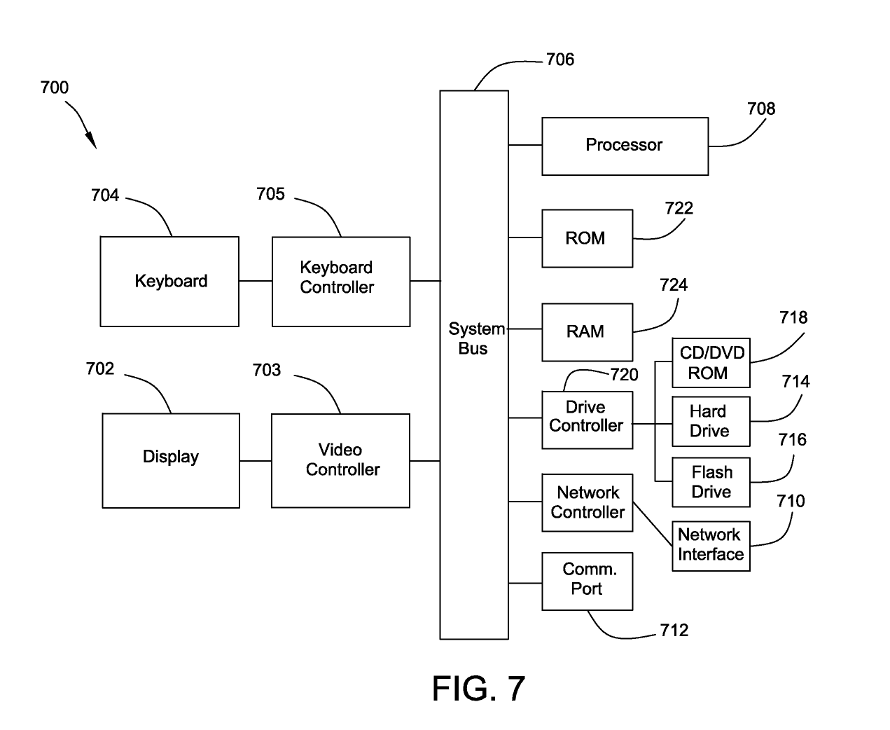

FIG. 7 is a schematic diagram showing hardware components of a social care network according to one embodiment. Those skilled in the art will realize that the management system 102 may include one or more computing devices described herein. The computing device 700, such as a computer, including a dedicated special-purpose support management device, includes a plurality of hardware elements, including a display 702 and a video controller 703 for presenting to the user an interface for interacting with the system. The computing device 700 further includes a keyboard 704 and keyboard controller 705 for relaying the user input via the user interface. Alternatively or in addition, the computing device 700 includes a tactile input interface, such as a touch screen. The display 702 and keyboard 704 (and/or touch screen) peripherals connect to the system bus 706. A processor 708, such as a central processing unit (CPU) of the computing device or a dedicated special-purpose support management processor, executes computer executable instructions comprising embodiments of the support management system, as described above. In embodiments, the computer executable instructions are received over a network interface 710 (or communications port 712) or are locally stored and accessed from a non-transitory computer readable medium, such as a hard drive 714, flash (solid state) memory drive 716, or CD/DVD ROM drive 718. The computer readable media 714-718 are accessible via the drive controller 720. Read Only Memory (ROM) 722 includes computer executable instructions for initializing the processor 708, while the Random Access Memory (RAM) 724 is the main memory for loading and processing instructions executed by the processor 708. The components illustrated in FIG. 1 can be implemented in one computing device or multiple computing devices connected over a network. Additionally, the user or member device may also use hardware components such as those illustrated in FIG. 7.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of managing care requests in a social care network comprising:
associating, by a care request processor, a plurality of individuals as members of the social care network
receiving, by the care request processor, care request information for an individual member of the social care network;
generating, by the care request processor, at least one task based on the received care request information;
posting, by the care request processor, the task to the social network;
receiving, by the care request processor, an acceptance of the task from a member of the social care network; and
receiving, by the care request processor, a completion indication of the task from the member of the social care network.

2. The method of claim 1 wherein the care request information is at least one clinical record containing clinical language for the individual member of the social care network.

3. The method of claim 2 further comprising translating, by the care request processor, clinical language to natural language.

4. The method of claim 3 wherein the task is generated from the natural language.

5. The method of claim 2 wherein the clinical record comprises at least one of electronic medical records, health insurance data and pharmacy benefits data.

6. The method of claim 1 wherein the care request information is received from the individual member of the social care network.

7. The method of claim 1 wherein the care request information is received from a networked application.

8. The method of claim 1 further comprising translating, by the care request processor, a description of a completed task to a clinical record.

9. A method of managing tasks in a social network comprising:
associating, by a task processor, a plurality of individuals as members of the social network
receiving, by the task processor, task information for an individual member of the social network;
posting, by the task processor, the task to the social network;
receiving, by the task processor, an acceptance of the task from a member of the social network;
alerting the members of the social network that an acceptance of the task was received; and
receiving, by the task processor, a completion indication of the task from the member of the social network.

10. A method of generating contextual advertisement placements in a task management system, the method comprising:
tracking, by a context processor, historical data for tasks accepted by individual and tasks not accepted by the individual;
analyzing, by the context processor, profile information for a plurality of users of the task management system;
associating, by the context processor, the individual with similar users and groups;
receiving, by the context processor, geolocation data for the individual;
analyzing, by the context processor, a personal health information record associated with the individual; and
placing, by the context processor, a contextual advertisement for the individual.

11. The method of claim 10 wherein the historical data includes the type of task.

12. The method of claim 10 wherein the groups include at least one of an employer and a preferred pharmacy.

13. The method of claim 10 wherein the contextual advertisement includes a coupon associated with a task.

14. A method of maintaining access to a personal health information record comprising:
associating, by an information record processor, a user with the personal health information record of a patient;
transmitting, by the information record processor, terms for accessing the personal health information record to the user;
receiving, by the information record processor, acceptance of the terms for accessing the personal health information record from the user; and
providing the user, by the information record processor, access to the personal health record.

15. The method of claim 14 further comprising storing a creator of the personal health information record.

16. The method of claim 14 further comprising associating, by a information record processor, a second user with the personal health information record of a patient.

17. The method of claim 14 further comprising providing the patient, by the information record processor, access to the personal health record.

18. The method of claim 14 further comprising providing the user access to the personal health record for a predefined period of time.

19. The method of claim 14 further comprising providing the user, by the information record processor, access to historical data associated with the personal health record.

20. The method of claim 14 wherein acceptance of the terms is indicated through an electronic signature.
